(19) United States
(12) Patent Application Publication
(10) Pub. No.: US 2015/0323412 A1
(43) Pub. Date: Nov. 12, 2015

(54) TOILET WATER DAMAGE PROTECTION KIT AND METHOD

(71) Applicant: AR VALVE GROUP, LLC., HOUSTON, TX (US)

(72) Inventors: AMBER STOLTZ, HOUSTON, TX (US); BRIAN K. HOLLAR, HOUSTON, TX (US)

(21) Appl. No.: 14/704,332

(22) Filed: May 5, 2015

Related U.S. Application Data
(63) Continuation-in-part of application No. 14/275,203, filed on May 12, 2014.

(51) Int. Cl. G01M 3/28; G05D 7/06; G05B 15/02; E03D 11/13; F16K 31/06

(52) U.S. Cl. CPC G01M 3/28; E03D 11/13; F16K 31/06; G05B 15/02; G05D 7/0629

(57) ABSTRACT

The present invention provides an easily mounted, self-contained, compact fluid leak detection kit and/or method. When water begins to flow through the kit housing, a flow switch triggers a timer mechanism such as a processor. As long as the flow continues, the timer mechanism will count down the amount of preset time. The kit provides a manual or computer controlled adjustment to set a predetermined delay time or shutdown time, which is adjustable to the normal operating cycle time of any particular toilet. In this way, the water is shut off as quickly as possible if a leak occurs. The kit may also provide overflow protection, reset to initial values, low battery indication, and bypass function with suitable hardware to implement each.

This is a continuation-in-part of U.S. application Ser. No. 14/275,203 filed May 12, 2014, which is incorporated herein by reference.

### BACKGROUND OF THE INVENTION

1. Field of the Invention

One possible embodiment of the present disclosure relates generally to the field of leak detection and water shutdown systems and, more specifically, to a self-contained compact fluid leak detection easily mounted kit that comprises an apparatus and/or method to reliably cut off the flow of water to fluid operated devices such as an appliance, toilet, and the like. Otherwise the compact, easily mounted kit allows normal operation of the toilet.

2. Background of the Invention

When left unattended, leaks in high rise condominium vacation homes and standalone vacation homes can cause damage throughout the building during the months that the vacation homes can be vacant. For that matter, if a homeowner is out for the day or week, a toilet leak can cause extensive damage. Unattended leaks in upper level condominiums can cause considerable damage throughout the building on all lower floors. High rise condominium owners living in another city can receive calls from the homeowner association about insurance against legal liabilities for the many lower condominiums that are extensively damaged.

Accordingly, home owners generally and home owner associations in high rise condominiums have long sought simple inexpensive easily mounted kits that greatly reduce likelihood of threats of legal liabilities and/or prevent extensive damage.

Moreover slow leaks in appliances such as toilets can also lead to costly water bills. Severe leaks can lead to devastating damage to homes and possibly even surrounding homes.

Prior art devices either do not provide simple to install kits that a homeowner or contractor can install with basic hand tools. As best as can be determined, the only existing prior art kit for the toilet does not protect against many types of disastrous toilet leaks.

Leak detection apparatuses and systems are well known in the art but for many reasons are not suitable and/or able to prevent damage and do not provide an easily mounted kit. The following patents discuss different background art related to the subject matter discussed above:

United States Patent Application No. 2013/0092242, published Apr. 18, 2013 to Guy, discloses an apparatus and method for fluid leak detection and shut down for a fluid distribution system having a total system flow rate. The apparatus includes a solenoid shutoff valve having a normally open state and an activated closed state with a flow capacity matched to the total fluid distribution system flow rate. The apparatus also has a primary fluid flow line and a smaller capacity secondary fluid flow line. The apparatus includes a flow sensor in fluid communication with the secondary fluid flow line, wherein the flow sensor has a perceptible output and a flow rate capacity less than the solenoid shutoff flow capacity. Operationally, the flow sensor receives a portion of the solenoid shutoff valve flow capacity in priority over the primary fluid flow line, allowing the flow sensor to detect minimal flow rates and using the perceptible output to activate the solenoid shutoff valve into the closed state. However, the device is complicated and monitors the entire water supply for an edifice rather than provide a convenient, easily mounted compact kit.

United States Patent Application No. 2012/0211094, published Aug. 23, 2012 to Quintana, discloses a device to shut-off a water supply to a toilet diverts water from a toilet fill valve to a shut-off valve that has a housing that includes a valve mechanism, a trip mechanism, and a trip circuit. The trip mechanism includes a rotational spring that urges closing of the valve mechanism. A trip latch is adapted to prevent closing of the valve mechanism except when withdrawn from the valve mechanism by a solenoid that is electrically connected to the trip circuit. The trip circuit includes at least one trip sensor input and a power source, such that when the trip circuit detects a fault condition on any of the trip sensors, the trip circuit connects power to the solenoid to withdraw the solenoid to close the valve mechanism. A rest knob may then be rotated to reset the valve mechanism into a valve-open position.

United States Patent Application No. 2010/0212748, published Aug. 26, 2010 to Davidoff, discloses systems and methods for detecting and preventing fluid leaks. A rate of flow of a portion of fluid flowing through a fluid distribution network over a period of time is monitored. A determination is made whether the rate of flow of the fluid over the period of time is greater than zero but so low that it indicates a leak in the water pipe. If the rate of flow over the period of time indicates a leak, then the flow of the liquid through the system is stopped and an indication is provided that a leak has been detected.

U.S. Pat. No. 6,675,826, issued Jan. 13, 2004 to Newman et al., discloses a flood prevention system including a double-latching solenoid valve that shuts off a water supply line in response to a moisture sensor detecting a leak in a plumbing system. The double-latching feature provides the solenoid's plunger with two positions of equilibrium. This minimizes electrical power consumption so that the flood prevention system can be battery operated. To minimize a buildup of hard water deposits, the valve includes a flexible diaphragm and is cycled periodically regardless of whether flooding occurs. The sensor includes multiple methods of mounting to a floor.

U.S. Pat. No. 6,612,323, issued Sep. 2, 2003 to Home, presents a safety valve provided for an appliance having an electrically operated water inlet valve for receiving water used during operation of the appliance. A valve body is connected to the water supply upstream of the inlet valve, the valve body having a flow path for allowing water to flow through the valve body to the inlet valve. An electrically operated solenoid is connected to a valve gate, the valve gate being movably carried within the valve body and movable between a closed position and an open position that allows water to flow through the flow path. A portion of an electrical current from an appliance control system to the inlet valve for opening the inlet valve is conducted to the solenoid for moving the gate to the open position. The gate is spring biased to the closed position for returning the gate to the closed position when the current ceases to flow.

U.S. Pat. No. 6,389,852, issued May 21, 2002 to Montgomery, discloses a water supply safety valve kit for an appliance in which the kit includes an individual solenoid actuated normally closed valve unit for each water supply line to the appliance and a control unit that plugs into a conventional electrical female household outlet. The control unit has a first outlet at the household line voltage and into which the power cord of the appliance plugs and a second lower voltage outlet responsive to current flow to the first outlet. A count down timer circuit and a low voltage output are activated by the current flow to the first outlet and lines connect that low voltage output to the solenoid valve unit to open the same. The countdown timer terminates the low voltage output after a preselected time period.

U.S. Pat. No. 6,367,096, issued Apr. 9, 2002 to Quintana, discloses a microprocessor-operated flow control device for a toilet to prevent flooding upon obstructing of a waste outlet of a toilet bowl also includes a leak detector for measuring water leakage from a toilet tank. The device includes a water level sensor assembly mounted on a clip held over a rim of the toilet bowl so as to hold the water level sensor assembly in a predetermined position within the toilet bowl, and a leak detecting element held in the interior of the toilet tank. If water bridges contacts on the water level sensor assembly, an electrical circuit or an RF connection is completed to the microprocessor in a housing, and an electric motor is actuated to drive a gear train to close a normally opened valve and shut off water to the water tank of the toilet. If a water leak is detected, an electrical or an RF signal is sent to the microprocessor to shut off water flow to the water tank.

U.S. Pat. No. 5,568,825, issued Oct. 29, 1996 to Faulk, discloses a system for detecting leakage and unwanted flow in a fluid supply within a building capable of detecting small leaks and shutting off flow when such occur. The system may be operated in a continuous mode or on a timed mode, and the system allows flow for a preset small time period before the shut-off is initiated. The system includes an inflow sensor, a discharge sensor and valve means to seal the supply conduit in the event of unwanted fluid flow or backflow in the discharge conduit. The system is extremely sensitive due to the provision of a by-pass conduit around a check-valve in the supply conduit, where the flow sensor is positioned in the by-pass conduit, such that small volume water flow must pass through the flow sensor.

The above art does not show a compact, easily mounted kit that can be easily installed by a homeowner to shut off all water going to a toilet before it enters the toilet. For the most part, the above prior art requires multiple sensors, inconvenient power requirements, in most cases very complex costly systems and in some cases may not reliably detect disastrous types of water leaks in the toilet or appliance. Only U.S. Pat. No. 6,367,096 provides a kit, but this patent operates on fluid level changes in the tank that may not change for numerous types of disastrous leaks from the toilet, e.g. a leak prior to entering the toilet. An urgent need exists for an improved leak detection and shutdown apparatus that requires less power to operate and has a less complicated configuration. Those of skill in the art will appreciate the present system which addresses the above and other problems.

### SUMMARY OF THE INVENTION

Accordingly, it is one object of the present invention to provide an improved leak detection and shutdown apparatus.

Another possible object is to provide a compact, easily mounted kit that can be connected as a complete package between the wall water outlet and the toilet input connector.

An additional possible object is to provide an automatic adjustment to the toilet water flush/fill cycle of any particular toilet.

An additional possible object is a single reset button that allows reinitialized operation of the unit after the water has been shut off with a single conveniently located reset button.

Another possible object of the present invention is to provide a leak detection apparatus with minimal power requirements and in one embodiment is simply a DC battery source that last a long time.

Yet another possible object of the present invention is to provide a leak detection apparatus that more accurately measures the flow of fluid from a fluid supply, specifically low volume fluid flow.

The present invention can be sold as a single box kit that is easily installed by a homeowner simply using two connectors prior to fluid reaching the toilet. This compact construction, which can be installed in five minutes or less, makes the kit very sellable by large home improvement companies

Yet another possible object of the present invention is to provide overflow protection using a programmed algorithm to control the device via a microcontroller based PCB (printed circuit board) or other component limiting the number of successive flushes in a (predetermined or calculated) period of time. In this way, the kit reduces the possibility of inadvertent overflow of the toilet.

Other possible objects and advantages of the present invention will become apparent from the following descriptions, taken in connection with the accompanying drawings, wherein, by way of illustration and example, an embodiment of the present invention is disclosed. However, it will be understood that the present invention is not limited to the above and/or other objects of the invention.

In accordance with the disclosure, the present invention provides a toilet leak detection kit comprising input and output connectors that connect the kit between the wall supply outlet and toilet inlet. A flow sensor detects when fluid from the fluid supply is flowing to the toilet inlet. A microcontroller based PCB circuit, processor, or similar device with timer operatively connects to the flow sensor and a latching solenoid moves between an open position that allows fluid flow through to the toilet inlet and a closed position that prevents fluid flow to the toilet inlet, the microcontroller based PCB circuit or similar device with timer being operatively connected to the latching solenoid to move the latching solenoid to the closed position after a shutoff time. A reset switch is operable to move the latching solenoid from the closed position to the open position.

In one embodiment, the apparatus may further comprise at least one battery to power the microcontroller based PCB circuit or similar device with timer, the latching solenoid, the bypass switch, and the reset switch.

In one possible embodiment, the timer, processor, or the like may further comprise an automatic adjustment operable to provide selective adjustment of the shutoff time to provide a predetermined shutoff time. One aspect of the microcontroller programming monitors the duration between flushing and completion of the refill of the tank. This time in conjunction with either the factory default cycle time or previous successive flush cycle times to calculate a running average to use as the variable for shutoff time.

The apparatus may further comprise a housing for the microcontroller based PCB circuit or similar device with timer, the flow sensor, and the latching solenoid. A reset switch may be positioned to be accessible from outside the housing.

In another embodiment, an apparatus to detect leaks in a toilet is disclosed comprising a housing with input and output connections operable to connect between a toilet inlet and a flush water fluid supply that supplies water to the toilet inlet. A flow sensor mounted to the housing that senses fluid to the toilet inlet. A microcontroller based PCB circuit or similar device mounted to the housing operatively connects to the flow sensor. A latching solenoid mounted to the housing moves between an open position that allows fluid flow to the toilet inlet and a closed position that prevents fluid flow to the toilet inlet, the microcontroller based PCB circuit or similar device being operably connected to the latching solenoid to move the latching solenoid to the closed position to shut off fluid flow when fluid flowing through the flow sensor exceeds a shutoff time.

The apparatus may comprise a reset switch electrically connected to move the latching solenoid from the closed position to the open position.

The apparatus may further comprise at least one DC power supply to power the microcontroller based PCB circuit or similar device, the latching solenoid, the bypass switch, and the reset switch.

In one embodiment, the flow sensor is operable to detect a predetermined minimum fluid flow above which the flow sensor produces a flow signal, the predetermined minimum being selected to be less than an unrestricted flow for a selected toilet. The flow sensor may further comprise normally open contacts that close when fluid flows through the flow sensor above the minimum fluid flow that produces the flow signal.

In one possible embodiment, the timer may comprise an adjustment operable to provide selective adjustment of the shutoff time to provide a predetermined shutoff time.

In another embodiment, the reset switch and the bypass switch are mounted to the housing in a position allowing access to operate the switches from outside the housing.

In yet another embodiment, the present invention provides a method to detect leaks in a toilet when the toilet is connected to a fluid supply, which may comprise the steps of providing a flow control apparatus with connections to fluidly connect between a toilet water supply and a toilet inlet for the toilet, providing a flow sensor that detects fluid flowing into the toilet inlet, providing a processor responsive to the flow sensor, and providing a latching solenoid moveable between an open position that allows fluid flow into the toilet inlet and a closed position that prevents fluid flow to the toilet inlet, the latching solenoid being operatively connected to the processor to terminate fluid flow from the fluid supply after a time period.

Other steps may comprise providing a reset switch to move the latching solenoid from the closed position to the open position and providing that the toilet water supply and a toilet inlet for the toilet are positioned within five feet of each other.

The method may comprise providing at least one DC power supply to power the microcontroller based PCB circuit or similar device with timer, the latching solenoid, the bypass switch, and the reset switch.

In yet another embodiment, the method may further comprise providing that the timer is operable to either self-adjust or otherwise adjust to a predetermined shutoff time for the shutoff time.

In one embodiment, the method may comprise the step of providing that the toilet water supply comprises a wall outlet adjacent to the toilet.

Another step may include mounting the microcontroller based PCB circuit or similar device with timer, the flow sensor, a power supply, and the latching solenoid to a housing or case.

A further step may include mounting a reset switch and/or the bypass switch, to the housing in a position that allows access to the reset switches from outside the housing.

In one embodiment, audio and/or visual alarm for leak or flapper malfunction may be produced by the kit if actual flush cycle duration exceeds either the factory default flush cycle duration or the running average of the flush cycle.

In one embodiment, audio and/or visual alarm for overflow protection if the device via a microcontroller based PCB (printed circuit board) or other component detects that the number of successive flush cycles in a (predetermined or calculated) period of time exceeds that of the programmed algorithm.

In one embodiment, audio and/or visual alarms may be produced by the kit for low battery indication and/or when the bypass function is used. The bypass function essentially turns off operation of the kit.

### BRIEF DESCRIPTION OF THE DRAWINGS

The accompanying drawings, which are incorporated in and constitute a part of this specification, illustrate an implementation of apparatus consistent with one possible embodiment of the present disclosure and, together with the detailed description, serve to explain advantages and principles consistent with the disclosure. In the drawings,

FIG. 1 illustrates an embodiment of a fluid leak detection apparatus in accord with one possible embodiment of the present invention.

FIG. 2 is an electrical wiring diagram of a fluid leak detection apparatus in accord with one possible embodiment of the present invention.

FIG. 3 is a diagram of a fluid leak detection apparatus installed on a toilet in accord with one possible embodiment of the present invention.

FIG. 4 is a perspective view of a fluid leak detection apparatus installed on a toilet in accord with one possible embodiment of the present invention.

The above general description and the following detailed description are merely illustrative of the generic invention, and additional modes, advantages, and particulars of this invention will be readily suggested to those skilled in the art without departing from the spirit and scope of the invention.

### DETAILED DESCRIPTION OF EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. A kit as used herein could include a package, housing, printed circuit board (PCB), apparatus, or the like. A self-contained compact kit, which may be referred to herein as kit, apparatus, leak detection apparatus, leak protection apparatus 10, or the like, is easily and quickly mounted between the water source and toilet inlet to completely control fluid flow into the toilet.

In one embodiment, leak detection apparatus 10 is a battery operated flow/stop system that is controlled by a solid state time delay relay. The time delay could be manually or automatically adjustable. If water continues to flow longer than a predetermined time period related to the flush time, then the leak detection device turns off the water. Due to low power draw, a standard DC battery will last at least one year in the present system. An annual battery replacement reminder may be sent by email or placed on the calendar when the Bluetooth option is utilized or may be produced by the self-contained kit utilizing lights or sound. Alternatively a battery voltage detection system may be utilized to show existing status and may predict long term battery status.

In one embodiment, when a predetermined minimum amount of water begins to flow through the conduit, a flow sensor such as a flow switch closes and applies voltage to the microcontroller 12. As the flow continues, a software implemented timer in the microcontroller will count down the amount of preset or calculated time before a signal is sent to the solenoid 22 to shut off fluid flow through kit 10. The microcontroller timer adjusts automatically to each application, such as different lengths of time to flush between, for example, a power flush toilet that lasts a few seconds and a flapper valve toilet that may take about thirty seconds. As one possibility, the actual time is recorded for each flush cycle after installation. The processor could then utilize a running average of the cycle times plus a buffer time as a variable for comparison to the current flush cycle time. When the flush cycle time exceeds the factory default time interval or the running average plus buffer interval, the microcontroller will send voltage to a relay or solenoid valve, which will stop the flow.

The flow can remain stopped indefinitely until a reset button is depressed manually. Accordingly, if a longer than normal flush time is exceeded, a leak is indicated. The fluid flow is stopped at the solenoid before the water goes to the toilet thus preventing any known type of toilet leak, of which many different types may occur. For example, the toilet bowl may receive continuous flow with little change in fluid level in the tank. A leak could occur at the input connector of the toilet, which results in otherwise flooding the bathroom. Some fluid will still flow onto the floor but it is quite limited. Recalls have been sent out for some types of power flush toilets due to explosions that apparently may result in continuous flow onto the floor of the bathroom.

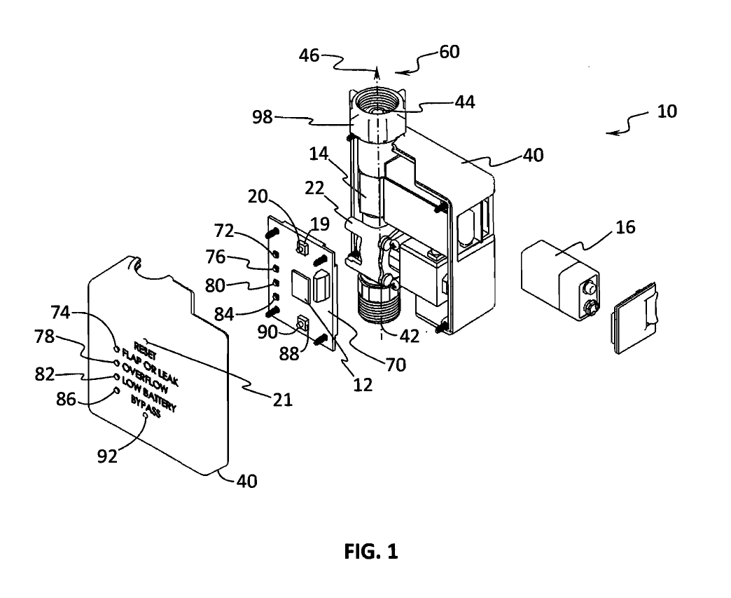

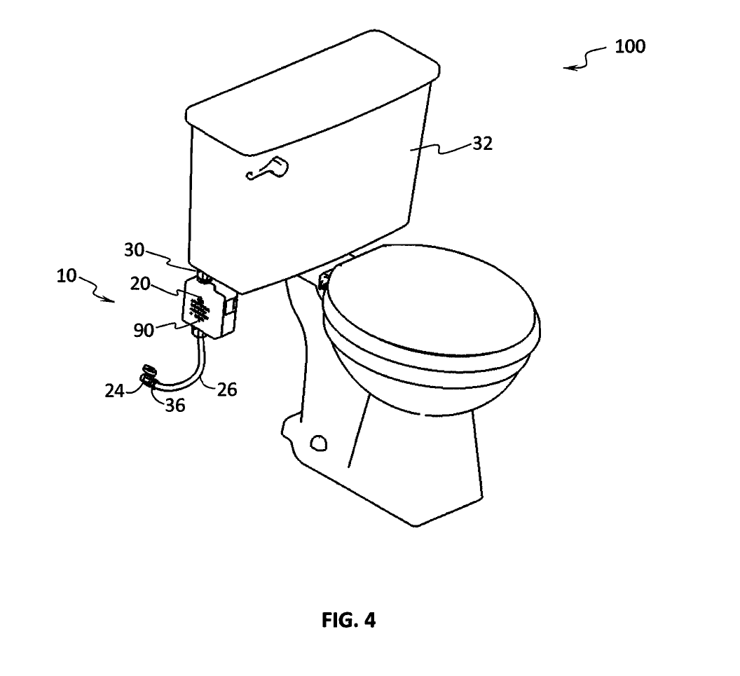

Turning now to the drawings, and more particularly FIG. 1, fluid leak detection apparatus 10 is shown in accord with one possible embodiment of the present invention. FIG. 4 shows one possible mounting on the toilet for fluid leak detection apparatus 10. Referring again to the non-limiting example of FIG. 1, leak detection apparatus 10 comprises housing 40 which contains flow switch 14, latching solenoid or other type of relay 22 to control fluid flow through the fluid leak detection apparatus 10, solid state microcontroller 12 mounted on PCB 70, and power supply 16. Latching solenoid valve 22 operates a valve that controls fluid flow through the fluid leak detection apparatus 10. Latching solenoid valve 22 may be referred to herein as a valve, solenoid or the like and may comprise a butterfly valve, gate valve or other type of mechanism. In this embodiment, latching solenoid 22 is fluidly connected to flow switch 14. An additional conduit may or may not be utilized between solenoid 22 and flow switch 14. In the operation mode, latching solenoid 22 is in a normally open position allowing fluid to pass there through. Latching solenoid 22 and flow switch 14 define flow path 60 designated by the dotted lines that flows along flow axis 46.

In operation, fluid enters leak detection apparatus 10 at fluid inlet 42 and travels along flow path 60 before exiting outlet 44 as indicated by flow axis 46. Flow switch 14 may have normally open contacts, which close when fluid greater than a minimum flow rate begins to flow through flow switch 14. The invention is not limited to any particular type of flow switch or flow sensor. The sensitivity of water flow of flow switch 14 can be selected or chosen for a desired appliance, e.g. an icemaker or a toilet. For example, the flow switch could be sensitive to a flow that is one-fifth of that of normal operation of the toilet. Once the contacts close, processor or microcontroller 12 acts as a timer that initiates a countdown for a predetermined shutdown time. A dedicated timer circuit could also be utilized but in this embodiment microprocessor 12 handles this function and other functions discussed herein. In one preferred embodiment, flow switch 14 can accommodate approximately a quarter of a gallon of fluid a minute. In other embodiments, flow switch 14 could be configured to handle a smaller flow rate for appliances, such as ice makers, water dispensers, and the like, which require less water to operate than a toilet. Flow switch 14 preferably detects total water flow into the toilet or appliance.

In one embodiment, flow switch 14 operates with a minimum flow rate for the current toilet valves of 0.5 liters/minute to sense flow. That is 0.13 US Gallons per minute. An icemaker minimum flow rate may need to be lower than this and may utilize a smaller diameter water input tubular.

In a preferred embodiment, the microcontroller 12 is a solid state microcontroller with software timer mounted on a PCB 70 with an automatically adjusted delay time to change the predetermined shutdown time for different applications. If the predetermined shutdown time has been reached on microcontroller 12, then latching solenoid 22 is energized into a closed position and blocks flow path 60 preventing further fluid flow. A latching relay remains latched in position, either closed or open, thereby eliminating the need for battery power to hold the relay in position. Significant battery power is only needed to switch the latch between the open and closed positions. Accordingly, battery life is quite long.

If the predetermined shutdown time is not reached due to cessation of fluid flow 60, then flow switch 14 no longer provides an energized feedback voltage to microcontroller 12, and the microcontroller 12 then resets to zero within its programming. The microcontroller 12 then starts timing from zero at the next cycle, i.e., when flow switch 14 is triggered by flow through flow path 60. On the other hand if the predetermined shutdown time is reached, then microcontroller 12 produces a signal to operate latching relay 22 thereby shutting off fluid flow through flow path 60. Reset Button 20, which engages reset switch 19, and which extends through reset hole 21 in case 40, provides a convenient way to restart operation of the toilet by switching latching relay back to allow flow along flow path 60. Additionally, pressing reset button 20 restores all programming variables to factory default.

It is desirable to have the predetermined shutdown time as short as possible to avoid excessive water damage. Since the flush time, the time water flows after a flush time is initiated, for each toilet is relatively constant, it would be desirable to base the predetermined shutdown time on the flush time. The flush time for each toilet may be different. If the predetermined shutdown time is less than the flush time, then a leak is not necessarily indicated, making it undesirable that the kit shuts off power to the toilet. In one preferred embodiment, microcontroller 12 is programmed to automatically determine a predetermined shutdown time based on the particular flush length (time from initial flushing to the time flush fluid stops flowing in the toilet) of the toilet to which it is installed. This obviates the need for a user to adjust a desired time period making operation considerably easier although another embodiment of the invention could utilize a manual adjustment.

In one embodiment, processor 12 provides that the predetermined shutdown time is equal to an average time of the three most recent flushes plus a fixed buffer time, assuming each flush time is less than a maximum time, e.g. one minute. However, the predetermined shutdown time could be calculated in many other ways, e.g., using a fixed multiplier of one or an average of flush times, dividing four flush times by three, using more or less than three flushes, or any other number of methods to determine a predetermined flush time. The microcontroller utilizes the closing and opening of contacts of flow switch 14 to measure the flush time or multiple flush times. From this information, the microcontroller is programmed to determine a predetermined shutdown time. If the predetermined shutdown period is exceeded, then latching solenoid 22, an electrically operated valve, is activated to close fluid flow path 60 thereby preventing what may be a leak.

In one embodiment, leak detection device 10 initially utilizes a default flush cycle time of 60 seconds. Microcontroller 12 then monitors the length of time the flow switch 14 completes the circuit thereby timing the flush cycle time or flush time. A flush cycle or flush time is preferably determined by measuring the closing and opening of the flow switch contacts that indicate fluid flow begins and ends. This would normally be the time that begins with pressing handle 62 (See FIG. 4) and when the fluid flow valve of the toilet shuts off—for instance after the reservoir fills to the desired level. Once three flush cycles have been completed successively, the microcontroller starts to calculate a running average for the flush cycle time. If the predetermined shutoff time after a flush exceeds the running average flush cycle time plus a 10 second buffer, solenoid 22 is activated to shut off the water to the toilet. Additionally, as described in more detail below, an audio and visual alarm will begin indicating that an internal or external leak has been detected. This allows the consumer to investigate the problem and repair the necessary toilet components. Once repairs are made, then leak detection device 10 can be reset utilizing button 20 that is labeled RESET for normal operation.

In other words, microprocessor or processor 12 is operatively connected to flow sensor 14 and latching solenoid 22. The processor 12 is programmed to utilize signals from the flow sensor 14 to measure a flush cycle time of said toilet from which a shutdown time is calculated. The processor 12 is programmed to activate the latching solenoid 22 if the processor detects that the flow sensor indicates a fluid flow time period greater than said shutdown time.

Once microprocessor 12 provides a signal to seal off fluid flow path 60, in one embodiment LED 72 is activated to provide a lighted warning indication. Microprocessor 12 may also turn on a sound indicator of some type. The microprocessor LED 72 provides a light at opening 74 in case 40, next to FLAP OR LEAK written on case 40. Thus, the user is advised that fluid leak detection apparatus 10 has determined that either a leak of some type has occurred or perhaps the flap has failed to seal in the toilet.

Microprocessor 12 may also be utilized to provide overflow protection by limiting the number of flushes within a selected time period. Most overflows from the toilet bowl occur because the user, in error, assumes that when the contents of the bowl do not immediately discharge from the toilet, additional flushes will force the plugging in the bowl to dislodge and then discharge. In order to mitigate this cause and effect, leak detection apparatus 10 only allows two flushes in an overflow detection period of time, which may be a three minute time period or any other suitable time period for a particular toilet. Testing has shown based on old toilet flow specifications that the majority of the toilets will be able to store at least two flush cycles of water within the bowl and not overflow. New toilets can accept even more. Once a third flush is initiated within the 3 minute time interval the microcontroller will shut the valve and stop any additional water flow to the toilet. An audio and visual alarm will begin to indicate that an overflow has been averted. For example, LED 76 may illuminate opening 78 adjacent the OVERFLOW warning on housing 40. The consumer should then investigate the problem and unplug the toilet with a plunger, if that will correct the issue. In the event that any solids not associated with normal toilet use has occurred it is then recommended that a plumber is called to troubleshoot and rectify the problem before resetting the device for normal operation utilizing button 21 adjacent the RESET label on case 40.

A low battery alarm consisting of both audio and visual cues may also be incorporated into the circuitry. In one embodiment, microcontroller 12 monitors battery 16 voltage and/or current. When the battery voltage is low, then LED 80 may be turned on to shine through opening 82 next to the label LOW BATTERY on case 40. Once the alarm trips the homeowner should replace the battery as soon as possible.

In one embodiment, depressing bypass button 90 through opening 92 for switch 88 controls microprocessor 12 to turn off any current alarms and open solenoid valve 22. In this embodiment, leak detection device 10 is bypassed. In the bypass mode, leak detection device 10 does not operate alarms that would normally close the solenoid valve during operation. In one embodiment, a sporadic audio/visual alarm will indicate that the device is in a bypass mode. LED 84 provides a light through opening 86 adjacent BYPASS written on case 40. Depressing the reset button 20 will restore the microcontroller 12 programming to its normal operation. It is imperative that the bypass function is used in emergency situations only. The bypass function should never be used in a situation where an external leak is occurring or the probability of an overflow may occur.

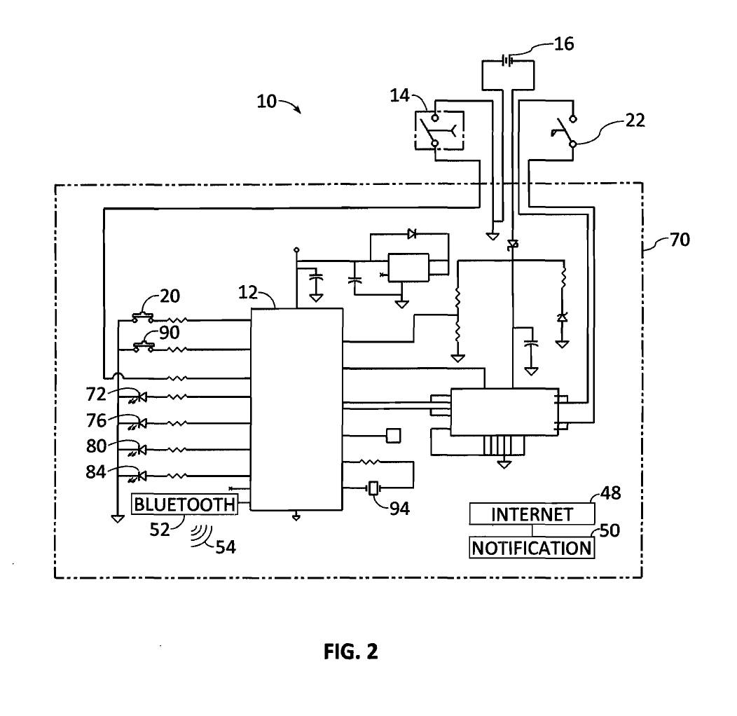

Looking now to FIG. 2, an electrical wiring diagram of fluid leak detection apparatus 10 is depicted in accord with one possible embodiment of the present invention. After fluid enters apparatus 10 and passes through flow switch 14, the normally open contacts of flow switch 14 will close and send a signal to the microcontroller 12. In a preferred embodiment, microcontroller 12 will utilize a programmed algorithm calculating the running average of the previous cycle durations to accommodate differing fill times for individual toilets and/or other appliances. After receiving a flow signal from flow switch 14, microcontroller 12 acting as a timer initiates a countdown sequence based on a predetermined or calculated flush cycle time plus a safety buffer and will continue this countdown as long as fluid flows through flow switch 14. Processor 12 is powered by power supply 16, which in a preferred embodiment is a DC battery, such as a standard 9 volt battery or any standard battery configuration. If the shutdown time is not reached, the flow switch contacts will open, thus resetting the microcontroller 12 timer to zero to initialize measuring the next water flow time period.

If this calculated shutdown time has been reached, microcontroller 12 will send a shutdown signal to solenoid 22. Solenoid 22, normally latched in an open position, will activate and latch in a closed position to block the flow of fluid into apparatus 10 until reset switch 20 is manually depressed by reset button 90. Reset switch 20, is powered by DC battery 16, communicates to the microcontroller to send a reverse polarity pulse from the DC battery to the latching solenoid 22, resetting it to the original open position with respect to fluid flow through apparatus 10 allowing normal flow.

Microprocessor 12 can be utilized to operate LEDs such as LEDs 72, 76, 80, and 84 for various operating conditions such as FLAP OR LEAK, OVERFLOW, LOW BATTERY, BYPASS, as noted by the corresponding explanations on case 40 shown in FIG. 1. Audio device 94 can be any number of devices that may be driven by microprocessor 12 to produce sound as may be desirable in conjunction with the various operating conditions.

In one embodiment, Bluetooth sensor 52 may be integrated into apparatus 10 to power on and produce signal 54 after latching solenoid 22 has been activated. If a Bluetooth enabled device is in close proximity to apparatus 10, signal 54 would then initiate pushing a message directly to a user's phone to alert them of issues with a toilet. In another embodiment, signal 54 would connect to internet application 48, which would send notification 50 to an end user.

In one embodiment, microcontroller 12 alternates between a sleeping state and a running state to check that all systems are operating properly. This process conserves the battery's power allowing a much longer battery life. The microcontroller acts almost instantaneously when any flow state or system status occurs that is outside the programmed parameters.

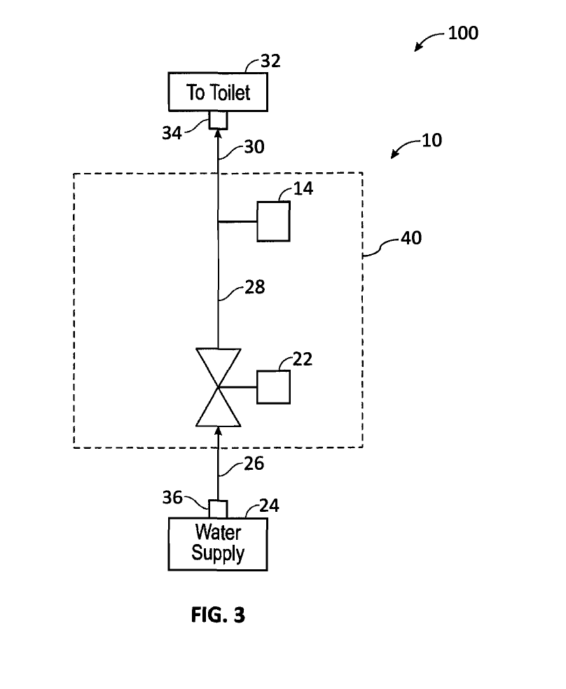

Looking now to FIG. 3, fluid leak detection system 100 is depicted in accord with one possible embodiment of the present invention. Leak detection apparatus 10 connects to water supply 24 through water supply hose 26 at fluid supply connection 36 on one end and is operably connected to toilet 32 at toilet connection 34 by outlet hose 30. It is understood that connection 34 may be differently located for different toilets and will preferably comprise a connection for fluid to supply flush water for the toilet. Fluid will enter leak detection apparatus 10 and pass through solenoid 22 and connection therebetween 28, which could be of various types including an additional conduit, before reaching flow switch 14. As discussed hereinbefore, fluid enters flow switch 14 and activates a timer, which may be a hardware device such as microprocessor 12. Once the timer has reached a predetermined shutdown time relative to the time currently accounted for, the processor will send a signal to close latching solenoid 22 and the corresponding valve and prevent further fluid flow through leak detection apparatus 10.

Finally, FIG. 4 is a perspective view of fluid leak prevention and/or detection system 100 in accord with one possible embodiment of the present invention. In one embodiment, fluid leak detection apparatus 10 is installed between water supply 24 and toilet 32. Flexible fluid line 26 connects to water supply 24 at fluid supply connection 36. In one embodiment, fluid leak detection kit 10 connects to toilet 32 by outlet hose 30 at toilet connection 34 (See FIG. 3). In another embodiment, fluid leak detection kit 10 connects directly to toilet 32. Water supply 24 may be a wall water supply that comes out of the wall or other suitable water supply for the toilet. Preferably conveniently located next to the toilet within five feet or three feet or two feet. Once handle 62 (see FIG. 4) is depressed, toilet 32 evacuates its contents and water begins to fill toilet 32. As water passes through leak detection apparatus 10, a timer will count time until water stops flowing through apparatus 10. If fluid flow stops before reaching a predetermined, manually adjusted, computer controlled, and/or calculated shutdown time, then apparatus 10 will revert to its standby operation until toilet 32 is used again. If fluid flow does not stop before reaching a predetermined shutdown time, then apparatus 10 will act to prevent further fluid flow from water supply 24 until reset switch 20A is depressed manually via reset button 20. This will prevent unwanted continuous water flow until the situation has been addressed. As discussed hereinbefore, depressing bypass button 90 turns off any current alarms and opens solenoid valve 22, though this should only be used in emergency situations.

The installation process of the fluid detection apparatus 10 in one embodiment is as follows:

1) Disconnect the ⅞″ ballcock nut on flexible toilet line 26 from ⅞″ ballcock stem protruding from the toilet.
2) Place wrench on the flats of device's lower connector. Connect the ⅞″ ballcock nut, which was just removed from the toilet, and tighten onto the ⅞″ ballcock stem at the bottom of the lower connector 42.
3) Connect the ⅞″ ballcock nut 98 (See FIG. 1) at the top of the device to the ⅞″ ballcock stem protruding from the toilet. Turn nut by hand until tight. Accordingly, in this embodiment, the kit connects directly to the toilet with flexible toilet line 26 connecting to the wall supply.

In operation, a predetermined shutdown time is determined by either manually or automatically measuring a length of a flush cycle time of a toilet from the time the handle is moved until water flow through the toilet stops. This may be about 30 seconds. For reliability purposes, 10 to 30 additional seconds may be added to the flush cycle time. The apparatus is mounted as indicated in FIG. 4. The predetermined or calculated shutdown time might then be 45 seconds, which is decided by the programming from the microcontroller 12, 12A. In one embodiment, an LED will light for each of the following conditions; flapper seal failure/leak, overflow avoidance, low battery, and bypass. The power LED's will be lit only if that specific status is present. The apparatus 10, 10A is now ready for operation. Normal flushing will not affect operation. However, if there is a problem, the unit shuts off the water flow from the supply outlet, which typically comes out of the wall adjacent the toilet. It will be appreciated that in this particular embodiment, the unit is not designed to detect leaks that occur upstream from the apparatus. The unit is normally connected as indicated and not to the input for the house because the flow rates are much different. The flow cycle for the whole house, if there is one, and the diameter of the flow switch for a toilet will not typically be adequate to provide whole house water supply monitoring.

While certain exemplary embodiments have been described in details and shown in the accompanying drawings, it is to be understood that such embodiments are merely illustrative of and not devised without departing from the basic scope thereof, which is determined by the claims that follow. Moreover, it will be appreciated that numerous inventions are disclosed herein which are taught in various embodiments herein and that the inventions may also be utilized within other types of equipment, systems, methods, and machines so that the invention is not intended to be limited to the specifically disclosed embodiments.

While certain exemplary embodiments have been described in details and shown in the accompanying drawings, it is to be understood that such embodiments are merely illustrative of and not devised without departing from the basic scope thereof, which is determined by the claims that follow. Moreover, it will be appreciated that numerous inventions are disclosed herein which are taught in various embodiments herein and that the inventions may also be utilized within other types of equipment, systems, methods, and machines so that the invention is not intended to be limited to the specifically disclosed embodiments.

What is claimed is:

1. A kit to detect leaks in a toilet when said kit is connected to a wall fluid supply, said toilet comprising a flush water inlet, said wall fluid supply comprising a supply outlet, said kit comprising:
input and output connectors that connect said kit between said supply outlet and said flush water inlet, respectively;
a flow sensor that indicates when fluid from said fluid supply is flowing to said toilet inlet;
a latching solenoid moveable between an open position that allows fluid flow through to said toilet inlet and a closed position that prevents fluid flow to said toilet inlet;
a processor operatively connected to said flow sensor and said latching solenoid, said processor being programmed to utilize said flow sensor to measure a flush cycle time of said toilet and calculate a shutdown time, said processor being programmed to activate said latching solenoid when a time duration of fluid flow to said toilet inlet is greater than said shutdown time.

2. The kit of claim 1, further comprising at least one battery to power said processor, said latching solenoid, and said flow sensor, said processor being programmed to detect a low battery power and produce a warning.

3. The kit of claim 1, wherein said processor utilizes a factory default time period as an initialized shutdown time prior to calculating said shutdown time.

4. The kit of claim 1, further comprising said processor being programmed to activate said latching solenoid in response to more than a selected number of flushes within a selected time period.

5. The kit of claim 4 further comprising a housing for said processor, said flow sensor and said latching solenoid, a reset switch positioned to be accessible from outside said housing to reset operation of said processor to initial settings, and a bypass switch accessible from outside said housing to bypass operation of said kit.

6. An apparatus to detect leaks in a toilet, comprising:
a housing comprising input and output connections operable to connect between a toilet inlet and a flush water fluid supply that supplies water to said toilet inlet;
a flow sensor mounted within said housing that senses fluid to said toilet inlet;
a processor mounted within said housing operatively connected to said flow sensor; and
a latching solenoid mounted within said housing moveable between an open position that allows fluid flow to said toilet inlet and a closed position that prevents fluid flow to said toilet inlet, said processor being operably connected to said latching solenoid to move said latching solenoid to said closed position when fluid flowing through said flow sensor exceeds a shutoff time.

7. The apparatus of claim 6, further comprising a reset switch mounted to said housing and being electrically connected to move said latching solenoid from said closed position to said open position.

8. The apparatus of claim 7, further comprising at least one battery power supply to power said processor, said latching solenoid, said flow sensor and said reset switch.

9. The apparatus of claim 6, wherein said processor is programmed to calculate a shutdown time, said processor being programmed to activate said latching solenoid when a time duration of fluid flow to said toilet inlet is greater than said shutdown time.

10. The apparatus of claim 9, wherein said processor utilizes a factory default time period as an initialized shutdown time prior to calculating said shutdown time.

11. The apparatus of claim 6, wherein said processor calculates an average flush cycle time for use in calculating a shutdown time, said processor being programmed to activate said latching solenoid when a time duration of fluid flow to said toilet inlet is greater than said shutdown time.

12. The apparatus of claim 7, further comprising a reset switch positioned to be accessible from outside said housing to reset operation of said processor to initial settings, and a bypass switch accessible from outside said housing to bypass operation of said latching solenoid.

13. A method for making a flow control apparatus to detect leaks in a toilet when said toilet is connected to a toilet water supply, comprising:
providing a flow control apparatus within a housing with connections on said housing to fluidly connect between said toilet water supply and a toilet inlet for said toilet;
providing a flow sensor within said housing that detects fluid flowing into said toilet inlet;
providing a processor within said housing responsive to said flow sensor;
providing a latching solenoid within said housing moveable between an open position that allows fluid flow into said toilet inlet and a closed position that prevents fluid flow to said toilet inlet, said latching solenoid being operatively connected to said processor to control fluid flow from said toilet water supply; and
providing that said processor is programmed to at least one of calculating a shutoff time or detecting excessive flushing of said toilet within a time period, said processor being further programmed to terminate fluid flow through said housing when at least one of said shutoff time is exceeded or when said excessive flushing occurs.

14. The method of claim 13 further comprising providing that said processor is programmed to both calculate said shutoff time and detect excessive flushing.

15. The method of claim 13 further comprising providing that said toilet water supply and said toilet inlet for said toilet are positioned within five feet of each other.

16. The method of claim 14, further comprising providing at least one battery powered DC power supply to power said processor, said latching solenoid, and said flow sensor.

17. The method of claim 16, further comprising providing that said processor is programmed to vary said shutoff time for different toilets depending on operation of said different toilets.

18. The method of claim 14, further comprising providing a reset switch positioned to be accessible from outside said housing to reset operation of said processor to initial settings, and a bypass switch accessible from outside said housing to bypass operation of said latching solenoid.

19. The method of claim 13, further comprising providing that said processor is programmed to time a length of at least one flush cycle to determine said shutoff time.

20. The method of claim 19, further comprising providing said processor is programmed to provide lighted indications of overflow conditions, leak conditions, and is further programmed to connect to the Internet to communicate at least said leak conditions.
